(19) United States
(12) Patent Application Publication
(10) Pub. No.: US 2017/0197358 A1
(43) Pub. Date: Jul. 13, 2017

(54) RIGID BASE SUBSTRATE, APPARATUS AND METHOD FOR PREPARING FLEXIBLE DISPLAY SUBSTRATE

(71) Applicants: BOE TECHNOLOGY GROUP CO., LTD., Beijing (CN); BEIJING BOE DISPLAY TECHNOLOGY CO., LTD., Beijing (CN)

(72) Inventors: Jianguo XING, Beijing (CN); Weitao CHEN, Beijing (CN)

(21) Appl. No.: 15/259,554

(22) Filed: Sep. 8, 2016

(30) Foreign Application Priority Data
Jan. 7, 2016 (CN) 201610009753.8

(51) Int. Cl. B29C 65/48; B29C 65/00

(52) U.S. Cl. CPC B29C 65/48; B29C 66/80; B29L 2031/3475

(57) ABSTRACT

The present invention provides a rigid base substrate, an apparatus and a method for preparing a flexible display substrate. The rigid base substrate comprises a base body having a bearing surface on which a base material used for forming a flexible display substrate is placed, the base body is provided with an inner cavity, and a plurality of through holes are provided between the hearing surface and the inner cavity to connect the inner cavity with the bearing surface. The rigid base substrate of the present invention does not need a bonding agent, and thus a cost of forming a flexible display substrate can be reduced; further, the flexible display substrate is protected from damage when the flexible display substrate is separated from the rigid base substrate; also, another flexible display substrate can be prepared using the rigid base substrate without cleaning the rigid base substrate, thereby increasing production efficiency.

### TECHNICAL FIELD

The present invention belongs to the field of display technology, and in particular relates to a rigid base substrate for preparing a flexible display substrate, an apparatus for preparing a flexible display substrate including the rigid base substrate and a method for preparing a flexible display substrate using the rigid base substrate.

### BACKGROUND

Employing a flexible display substrate as a substrate of a display device is one of future development directions, but at present, there are many problems existing in the process of preparing a flexible display substrate, resulting in a high cost and a low product yield.

At present, it is required to use a bonding agent to bond a base material for forming a flexible display substrate onto a rigid base substrate (which is generally a glass substrate) in the process of preparing the flexible display substrate, and then a pattern of the flexible display substrate is formed on the base material. After finishing the preparation of the flexible display substrate, the rigid base substrate is separated from the formed flexible display substrate by heating the bonding agent.

At least the following problems exist in the method for preparing a flexible display substrate in the prior art described above:

1. While the bonding agent is being heated, a case easily occurs in which temperature is not controlled appropriately, causing a damage to the flexible display substrate when stripping off the formed flexible display substrate;

2. It is difficult to remove the bonding agent remaining on the flexible display substrate;

3. After finishing the preparationof the flexible display substrate, the bonding agent may also remain on the rigid base substrate, so it must be cleaned before preparing another flexible display substrate; and

4. Using a bonding agent may increase a cost of preparing a flexible display substrate.

### SUMMARY

The present invention intends to solve at least one of the technical problems existing in the prior art described above, and proposes a rigid base substrate, an apparatus for preparing a flexible display substrate including the rigid base substrate and a method for preparing a flexible display substrate using the rigid base substrate. There is no need to use a bonding agent to fix a base material (used for forming a flexible display substrate) onto a rigid base substrate, so that a flexible display substrate can be protected from damage and no bonding agent will remain on the rigid base substrate when the flexible display substrate is separated from the rigid base substrate. Thus another flexible display substrate can be prepared without cleaning the rigid base substrate, and a cost can be reduced.

According to an aspect of the invention, there is provided a rigid base substrate, comprising a base body having a bearing surface on which a base material used for forming a flexible display substrate is placed. The base body is provided with an inner cavity, and a plurality of through holes are provided between the bearing surface and the inner cavity to connect the inner cavity with the bearing surface.

According to an embodiment of the invention, the base body may be made of a metal or a hard PVC.

According to an embodiment of the invention, projections of the plurality of through holes on the bearing surface may present a matrix arrangement.

According to an embodiment of the invention, projections of the plurality of through holes on the bearing surface may be distributed uniformly.

According to an embodiment of the invention, a pressure detecting unit may be provided in the inner cavity of the base body, and is used for detecting gas pressure in the inner cavity.

According to an embodiment of the invention, the inner cavity of the base body may be connected to a gas pumping device and a gas feeding device via a vent pipe, respectively.

According to an embodiment of the invention, the gas pumping device and the gas feeding device may be provided below or aside the base body.

According to another aspect of the invention, there is provided an apparatus for preparing a flexible display substrate, comprising the rigid base substrate according to the invention, a gas pumping device and a gas feeding device. The inner cavity of the base body of the rigid base substrate is connected to the gas pumping device and the gas feeding device via a vent pipe, respectively.

According to another aspect of the invention, there is provided a method for preparing a flexible display substrate, comprising: placing a base material used for forming the flexible display substrate on the rigid base substrate according to the invention, wherein the inner cavity of the base body of the rigid base substrate is connected to a gas pumping device and a gas feeding device via a vent pipe, respectively; pumping gas out of the inner cavity by the gas pumping device, to fix the base material; forming a pattern of the flexible display substrate on the base material; and feeding gas into the inner cavity by the gas feeding device, to separate the formed flexible display substrate from the rigid base substrate.

In the rigid base substrate according to the present invention, a pressure difference may be formed between two sides of the base material (used for forming a flexible display substrate) placed on the bearing surface of the base body by changing gas pressure in the inner cavity of the base body of the rigid base substrate, so that the base material is closely stuck onto the base body of the rigid base substrate, or the base material is separated from the rigid base substrate. Compared to the prior art, there is no need, in the technical solution according to the present invention, to use a bonding agent to fix a base material to a rigid base substrate, and thus a cost of preparing a flexible display substrate can be reduced. Further, there is no need to separate a base material from a rigid base substrate by means of heating, so that a flexible display substrate can be protected from damage and no bonding agent will remain on the rigid base substrate when the flexible display substrate is separated from the rigid base substrate. Thus, another flexible display substrate can be prepared without cleaning the rigid base substrate, thereby increasing efficiency of production.

### BRIEF DESCRIPTION OF THE FIGURES

The accompanying drawings, which constitute a part of the specification, are provided for a further understanding of the present invention, and for explaining the present invention along with the following specific implementations, but not intended to limit the present invention, in which:

FIG. 1 is a schematic diagram of a rigid base substrate according to an embodiment of the invention;

FIG. 2 is a schematic diagram of fixing a base material onto a rigid base substrate;

FIG. 3 is a schematic diagram of separating a flexible display substrate from a rigid base substrate; and

FIG. 4 is a flow chart of a method for preparing a flexible display substrate according to an embodiment of the invention.

### DETAILED DESCRIPTION

The specific implementations of the present invention will be described in detail below in conjunction with the drawings. It should be understood that specific implementations to be described herein are merely used for illustrating and interpreting the present invention and not for limiting the present invention.

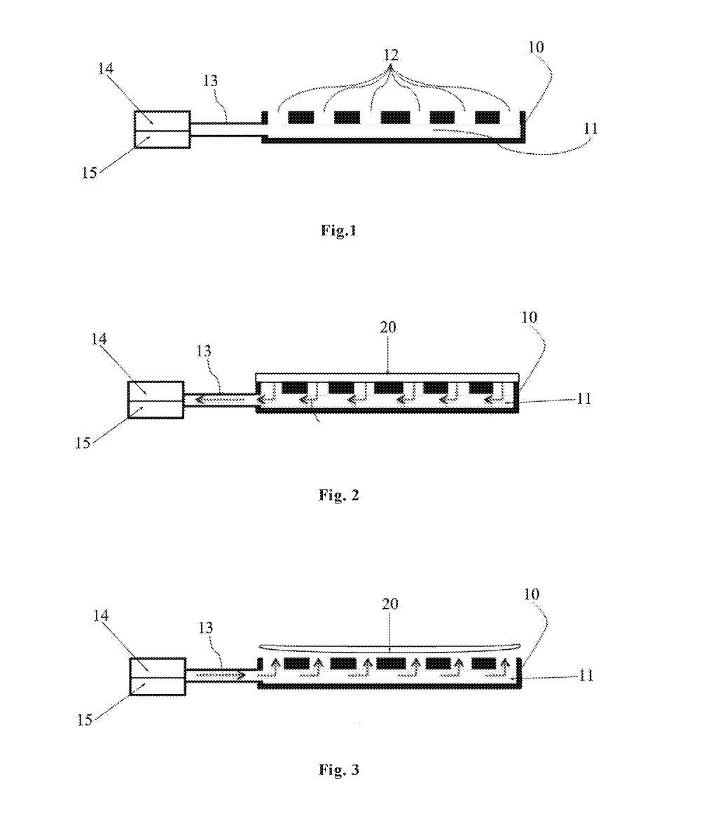

FIG. 1 is a schematic diagram of a rigid base substrate according to an embodiment of the invention, FIG. 2 is a schematic diagram of fixing a base material onto a rigid base substrate, and FIG. 3 is a schematic diagram of separating a flexible display substrate from a rigid base substrate.

Referring to FIGS. 1 to 3, the rigid base substrate according to an embodiment of the invention includes a base body 10 having a bearing surface (e.g. an upper surface of the base body 10), on which a base material 20 for forming a flexible display substrate is placed. The base body 10 is provided with an inner cavity 11, and there is provided a plurality of through holes 12 between the bearing surface and the inner cavity 11, to connect the inner cavity 11 with the bearing surface.

According to an embodiment of the invention, when the base material 20 is placed on the bearing surface (refer to FIG. 2), the base material 20 can completely cover all of the through holes 12. The inner cavity 11 of the base body 10 may be connected to a gas pumping device 14 and a gas feeding device 15 through a vent pipe 13, respectively.

After the base material 20 is placed on the bearing surface of the base body 10, the gas pumping device 14 pumps gas out of the inner cavity 11 through the vent pipe 13, a direction of gas flow in the inner cavity 11 is illustrated by arrows in FIG. 2, gas pressure in the inner cavity II is decreased, thereby forming a pressure difference between two sides of the base material 20, and causing the base material 20 to closely stick to the bearing surface of the base body 10. After fixing the base material 20 onto the bearing surface, a pattern of a flexible display substrate may be formed on the base material 20.

After forming the pattern of the flexible display substrate, the gas feeding device 15 feeds gas into the inner cavity 11 through the vent pipe 13, a direction of gas flow in the inner cavity 11 is illustrated by arrows in FIG. 3, and gas pressure in the inner cavity 11 is increased, until the gas pressure in the inner cavity 11 is close to, equal to or slightly higher than gas pressure of the environment, so that the flexible display substrate can be easily took off from the base body 10.

Although the gas pumping device 14 and the gas feeding device 15 are described as two separate components, the present invention is not limited thereto. For example, the gas pumping device 14 and the gas feeding device 15 may be formed into one device having both gas pumping and gas feeding functions, for example, a vacuum pump.

The gas pumping device 14 and the gas feeding device 15 may be provided below or aside the base body 10, to prevent the gas pumping device 14 and/or the gas feeding device 15 from disturbing the process of forming a flexible display substrate.

According to an embodiment of the invention, a material of the base body 10 may be a metal or a hard PVC, so that the base body 10 is rigid, but the present invention is not limited thereto. Other materials having a rigid characteristic may be employed to prepare the base body 10.

According to an embodiment of the vention, projections of the through holes 12 on the bearing surface may present a matrix arrangement, and in addition, the projections of the through holes 12 on the bearing surface may be distributed uniformly, so that a force is evenly applied to the base material 20.

According to an embodiment of the invention, a pressure detecting unit (not illustrated in the drawings), which is used for detecting gas pressure in the inner cavity 11, may be provided in the inner cavity 11. When gas is pumped out of the inner cavity 11 or fed into the inner cavity 11, a pressure parameter in the inner cavity 11 may be obtained in time, so as to control operation of gas pumping or gas feeding. For example, when gas is being fed into the inner cavity 11, according to gas pressure in the inner cavity 11 detected by the pressure detecting unit, feeding gas into the inner cavity 11 may be stopped in a case where gas pressure in the inner cavity 11 is equal to or slightly greater than gas pressure of the environment in which an upper surface of the flexible display substrate is located, so as to avoid insufficient gas pressure in the inner cavity 11 which results in a case in which the flexible display substrate cannot be took off from the base body 10, and to prevent excessive pressure in the inner cavity 11 which results in a case where the flexible display substrate falls off the base body 10.

In the rigid base substrate according to the present invention, a pressure difference may be formed between two sides of the base material 20 (used for forming a flexible display substrate) placed on the bearing surface of the base body 10 by changing gas pressure in the inner cavity 11 of the rigid base substrate, so that the base material 20 is closely stuck onto the base body 10 of the rigid base substrate, or the base material 20 is separated from the rigid base substrate. Compared to the prior art, there is no need, in the technical solution according to the present invention, to use a bonding agent to fix a base material to a rigid base substrate, and thus a cost of preparing a flexible display substrate can be reduced. Further, there is no need to separate a base material from a rigid base substrate by means of heating, so that a flexible display substrate can be protected from damage and no bonding agent will remain on the rigid base substrate when the flexible display substrate is separated from the rigid base substrate. Thus, another flexible display substrate can be prepared without cleaning the rigid base substrate, thereby increasing efficiency of production.

According to another aspect of the present invention, there is provided an apparatus for preparing a flexible display substrate, which includes the rigid base substrate according to the present invention, a gas pumping device and a gas feeding device. An inner cavity of a base body of the rigid base substrate is connected to the gas pumping device and the gas feeding device via a vent pipe, respectively.

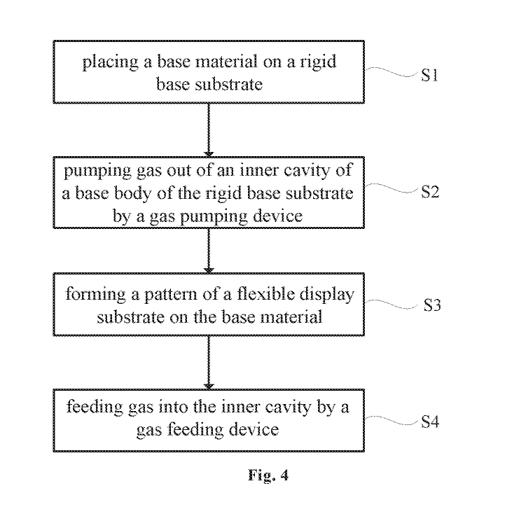

FIG. 4 is a flow chart of a method for preparing a flexible display substrate according to an embodiment of the invention.

As shown in FIG. 4, the method for preparing a flexible display substrate according to the embodiment of the invention includes:

S1: placing a base material used for forming a flexible display substrate on the rigid base substrate according to the present invention, wherein an inner cavity of a base body of the rigid base substrate is connected to a gas pumping device and a gas feeding device via a vent pipe, respectively;

S2: pumping, by the gas pumping device, gas out of the inner cavity, to fix the base material;

S3: forming a pattern of a flexible display substrate on the base material; and

S4: feeding, by the gas feeding device, gas into the inner cavity, to separate the formed flexible display substrate from the rigid base substrate.

In step S1, after placing a base material used for forming a flexible display substrate on the rigid base substrate according to the present invention, the base material may completely cover all through holes provided on a bearing surface of the base body. In step S2, after pumping gas out of the inner cavity, gas pressure in the inner cavity may decline, so that a pressure difference is formed between two sides of the base material, causing the base material to be fixed onto the rigid base substrate. In step S3, the pattern formed on the base material may include (but is not limited to) structures such as a thin film transistor, a pixel electrode, a signal line (e.g. a gate line, a data line, a common electrode line, etc.) and the like. In step S4, after feeding gas into the inner cavity, gas pressure in the inner cavity may increase, so that the flexible display substrate can be easily took off from the rigid base substrate.

It can be understood that the foregoing implementations are merely exemplary implementations used for describing the principle of the present invention, but the present invention is not limited thereto. Those of ordinary skill in the art may make various variations and modifications without departing from the spirit and essence of the present invention, and these variations and modifications shall fall into the protection scope of the present invention.

1. A rigid base substrate, comprising a base body having a bearing surface on which a base material used for forming a flexible display substrate is placed, wherein the base body is provided with an inner cavity, and a plurality of through holes are provided between the bearing surface and the inner cavity to connect the inner cavity with the bearing surface.

2. The rigid base substrate according to claim 1, wherein the base body is made of a metal or a hard PVC.

3. The rigid base substrate according to claim 1, wherein projections of the plurality of through holes on the bearing surface present a matrix arrangement.

4. The rigid base substrate according to claim 1, wherein projections of the plurality of through holes on the bearing surface are distributed uniformly.

5. The rigid base substrate according to claim 1, wherein a pressure detecting unit is provided in the inner cavity of the base body, and is used for detecting gas pressure in the inner cavity.

6. The rigid base substrate according to claim 1, wherein the inner cavity of the base body is connected to a gas pumping device and a gas feeding device via a vent pipe, respectively.

7. The rigid base substrate according to claim 6, wherein the gas pumping device and the gas feeding device are provided below or aside the base body.

8. An apparatus for preparing a flexible display substrate, comprising the rigid base substrate according to claim 1, a gas pumping device and a gas feeding device, wherein the inner cavity of the base body of the rigid base substrate is connected to the gas pumping device and the gas feeding device via a vent pipe, respectively.

9. The apparatus for preparing a flexible display substrate according to claim 8, wherein the gas pumping device and the gas feeding device are provided below or aside the base body.

10. The apparatus for preparing a flexible display substrate according to claim 8, wherein the base body is made of a metal or a hard PVC.

11. The apparatus for preparing a flexible display substrate according to claim 8, wherein projections of the plurality of through holes, which are provided on the bearing surface of the base body, on the bearing surface present a matrix arrangement.

12. The apparatus for preparing a flexible display substrate according to claim 8, wherein projections of the plurality of through holes, which are provided on the bearing surface of the base body, on the bearing surface are distributed uniformly.

13. The apparatus for preparing a flexible display substrate according to claim 8, wherein a pressure detecting unit is provided in the inner cavity of the base body, and is used for detecting gas pressure in the inner cavity.

14. A method for preparing a flexible display substrate, comprising:
placing a base material used for forming the flexible display substrate on the rigid base substrate according to claim 1, wherein the inner cavity of the base body of the rigid base substrate is connected to a gas pumping device and a gas feeding device via a vent pipe, respectively;
pumping, by the gas pumping device, gas out of the inner cavity, to fix the base material;
forming a pattern of the flexible display substrate on the base material; and
feeding, by the gas feeding device, gas into the inner cavity, to separate the formed flexible display substrate from the rigid base substrate.

15. The method for preparing a flexible display substrate according to claim 14, wherein the gas pumping device and the gas feeding device are provided below or aside the base body.

16. The method for preparing a flexible display substrate according to claim 14, wherein the base body is made of a metal or a hard PVC,

17. The method for preparing a flexible display substrate according to claim 14, wherein projections of the plurality of through holes, which are provided on the bearing surface of the base body, on the bearing surface present a matrix arrangement.

18. The method for preparing a flexible display substrate according to claim 14, wherein projections of the plurality of through holes, which are provided on the bearing surface of the base body, on the bearing surface are distributed uniformly.

19. The method for preparing a flexible display substrate according to claim 14, wherein a pressure detecting unit is provided in the inner cavity of the base body, and is used for detecting gas pressure in the inner cavity.
